(19) United States
(12) Patent Application Publication
(10) Pub. No.: US 2015/0287332 A1
(43) Pub. Date: Oct. 8, 2015

(54) Distance Education Method and Server Device for Providing Distance Education

(71) Applicant: Memowell Ent. Co. Ltd., Taipei City (TW)

(72) Inventors: Pei-Jen Tseng, Taipei City (TW); Chih-Li Tseng, Taipei City (TW); Chih-Yeh Tseng, Taipei City (TW)

(21) Appl. No.: 14/676,042

(22) Filed: Apr. 1, 2015

(30) Foreign Application Priority Data
Apr. 8, 2014 (TW) 103112828

(51) Int. Cl. G09B 7/02; H04L 29/08; H04L 29/06

(52) U.S. Cl. CPC G09B 7/02; H04L 67/42; H04L 67/10

(57) ABSTRACT

A distance education method to be implemented by a server device, and includes transmitting education course material to a client electronic device, which prompts for user input of a response to an interactive inquiry of the education course material and transmits the response to a server device, providing a solution to the interactive inquiry to the client electronic device, which prompts for user input of a correction to the response and transmits the correction to the server device, and generating an evaluation result, which is associated with a user learning outcome of the education course material, based on the correction and the solution.

### CROSS-REFERENCE TO RELATED APPLICATION

This application claims priority of Taiwanese Patent Application No. 103112828, filed on Apr. 8, 2014.

### FIELD

The disclosure relates to a distance education method and a server device for providing distance education, more particularly to a method and a server device for providing distance education foreign language courses.

### BACKGROUND

Distance education refers to a mode of education using communication media, such as television or the Internet, for breaking out of space and time limitations. Students who join distance education may take distance education courses anytime and anywhere without going to a specific location at specific times for attending classes. Furthermore, interactive participation of the distance education courses among the students may be realized by means of radio/television broadcast, the Internet, a telephone line, etc., for achieving a better learning outcome.

However, conventional distance education usually provides educational materials and knowledge one-sidedly, such that the effect of learning by the students may hardly be evaluated by an institution that provides the distance education.

### SUMMARY

Therefore, an object of the disclosure is to provide a distance education method and a server device for providing distance education which are able to evaluate a learning outcome of a user.

In a first aspect of the disclosure, a distance education method is to be implemented by a server device which communicates with a client electronic device through a network. The distance education method includes the steps of:

after receiving a learning request from the client electronic device, transmitting education course material to the client electronic device, the education course material including an interactive inquiry and enabling the client electronic device to prompt for user input of a response to the interactive inquiry and to transmit the response to the server device;

providing a solution to the interactive inquiry to the client electronic device, the solution enabling the client electronic device to prompt for user input of a correction to the response and to transmit the correction to the server device;

after receiving the correction from the client electronic device, generating an evaluation result, which is associated with a user learning outcome of the education course material, based on the correction and the solution.

In a second aspect of the disclosure, a distance education method is to be implemented by a client electronic device which communicates with a server device through a network. The distance education method includes the steps of:

transmitting a learning request to the server device, the learning request enabling the server device to transmit education course material to the client electronic device, the education course material including an interactive inquiry;

prompting for user input of a response to the interactive inquiry of the education course material;

transmitting the response to the server device;

obtaining a solution to the interactive inquiry from the server device;

prompting for user input of a correction of the response; and

transmitting the correction to the server device, the correction enabling the server device to generate an evaluation result, which is associated with a user learning out come of the education course material, based on the correction and the solution.

In a third aspect of the disclosure, a server device is configured for providing distance education. The server device communicates with a client electronic device through a network and includes a server-end communication interface, and a server-end processor module coupled electrically to the server-end communication interface. The server-end communication interface is configured to connect to the network. The server-end processor module is coupled electrically to the server-end communication interface, and is configured to:

after receiving the learning request via the server-end processor module, transmit education course material to the client electronic device via the server-end processor module, the education course material including an interactive inquiry and enabling the client electronic device to prompt for user input of a response to the interactive inquiry and to transmit the response to the server device,

provide a solution to the interactive inquiry to the client electronic device, the solution enabling the client electronic device to prompt for user input of a correction to the response and to transmit the correction to the server device, and

after receiving the correction from the client electronic device via the server-end communication interface, generate an evaluation result, which is associated with a user learning outcome of the education course material, based on the correction and the solution.

### BRIEF DESCRIPTION OF THE DRAWINGS

Other features and advantages of the disclosure will become apparent in the following detailed description of the embodiments with reference to the accompanying drawings, of which:

FIG. 1 is a block diagram illustrating a first embodiment and a third embodiment of a server device for providing distance education according to the disclosure;

FIG. 2 is a block diagram illustrating a second embodiment of the server device for providing distance education according to the disclosure;

FIG. 3 is a flow chart illustrating a first embodiment of a distance education method according to the disclosure; and

FIG. 4 is a flow chart illustrating a second embodiment of the distance education method according to the disclosure.

### DETAILED DESCRIPTION

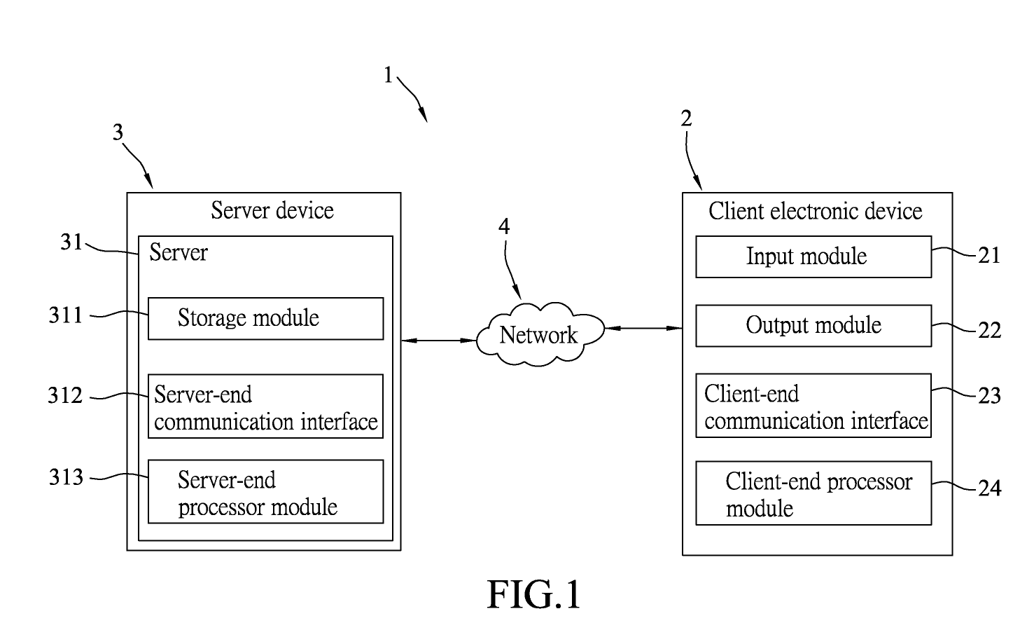

Referring to FIG. 1, a language learning system 1 includes a client electronic device 2 and a first embodiment of a server device 3 that provides distance education according to the disclosure.

The client electronic device 2 includes an input module 21, an output module 22, a client-end communication interface 23 configured to connect to a network 4, and a client-end processor module 24 coupled electrically to the input module 21, the output module 22 and the client-end communication interface 23.

The server device 3 includes a server 31. The server includes a storage module 311, a server-end communication interface 312 configured to connect to the network 4, and a server-end processor module 313 coupled electrically to the storage module 311 and the server-end communication interface 312. The storage module 311 stores a learning scheduling program and a learning evaluation program.

When the client-end processor module 24 receives user input of a learning request via the input module 21, the client-end processor module 24 transmits the learning request via the client-end communication interface 23 to the server-end communication interface 312. When the server-end processor module 313 receives the learning request from the client electronic device 2 via the server-end communication interface 312, the server-end processor module 313 executes the learning scheduling program to transmit education course material via the server-end communication interface 312 to the client-end communication interface 23. The education course material is stored in advance in the storage module 311.

The education course material includes at least audio/video (AV) material and text material corresponding to the AV material. The AV material includes at least one lesson audio/video which is associated with a language learning course, and at least one explanatory audio/video which is associated with the lesson audio/video. The lesson audio/video includes utterances of a plurality of lesson phrases that are associated with a foreign language desired to be learned (for example, German). The explanatory video includes utterances of a plurality of explanatory statements which are associated with the lesson phrases. The text material includes texts of the plurality of lesson phrases, and texts of the plurality of explanatory statements. The AV material may include both audio content and video content, or may include merely audio content. In this embodiment, the education course material further includes at least one interactive inquiry.

When the client-end processor module 24 prompts user for input of a response to the interactive inquiry of the education course material and obtains the response via the input module 21, the client-end processor module transmits the response to the server-end communication interface 312 via the client-end communication interface 23. When the server-end processor module 313 receives the response from the client electronic device 2 via the server-end communication interface 312, the server-end processor module 313 executes the learning scheduling program for transmitting a solution (e.g., a correct response or a hint to the correct response) to the interactive inquiry of the education course material via the server-end communication interface 312 to the client-end communication interface 23. The solution to the interactive inquiry of the education course material is stored in advance in the storage module 311. When the client-end processor module 24 receives the solution from the server device 3 via the client-end communication interface 23, the client-end processor module 24 controls the output module 22 to output the solution.

Depending upon the interactive inquiry, the response may be, but is not limited to, a user uttering the lesson phrases in the foreign language, a translation of the texts of the lesson phrases, a translation of the lesson phrases after listening to the utterances of the lesson phrases of the lesson audio/video (e.g., the lesson phrase of “Ich mag lernen” is translated into “I like learning” after listening to the lesson phrase of “Ich mag lernen”), and/or transcribing the lesson phrases after listening to the utterances of the lesson phrases of the lesson audio/video (e.g., the words “Ich mag lernen” are transcribed after listening to the utterances of the lesson phrase of “Ich mag lernen”). When the response is the user's utterance of the lesson phrases, the input module 21 includes a sound recorder, and the solution is given by way of, for example, playing the utterances of the explanatory statements of the explanatory video that correspond to the lesson phrases or the utterances of the lesson phrases of the lesson video. When the response is the translation of the texts of the lesson phrases or the translation of the lesson phrases after listening to utterance s thereof, the input module 21 includes a keyboard, and the solution is given by way of, for example, displaying the texts of the explanatory statements that correspond to the lesson phrases. When the response is transcribing the lesson phrases after listening to the utterances thereof, the solution is given by way of, for example, displaying the texts of the lesson phrases.

After the solution is outputted, the client-end processor module 24 subsequently prompts the user for input of a correction of the response previously made to the interactive inquiry via the input module 21, and transmits the correction to the server-end communication interface 312 via the client-end communication interface 23. When the server-end processor module 313 receives the correction from the client electronic device 2 via the server-end communication interface 312, the server-end processor module 313 executes the learning evaluation program to generate an evaluation result, which is associated with a user learning outcome of the education course material, based on the correction and the correct response, and subsequently executes the learning scheduling program to provide another suitable education course material to the client electronic device 2 based on the evaluation result.

It is noted that, when the response is uttering the lesson phrases, the correction includes, for example, repeating once again the utterance of mispronounced words of the lesson phrases. In this way, the server-end processor module 313 is able to generate the evaluation result based on the number of words that were repeated once again. When the response is the translation of the texts of the lesson phrases or the translation of the lesson phrases after listening to the utterances of the lesson phrases, the correction includes, for example, translating once again those words in the lesson phrases which were mistranslated previously. In this way, the server-end processor module 313 is able to generate the evaluation result based on the number of the words that were translated once again.

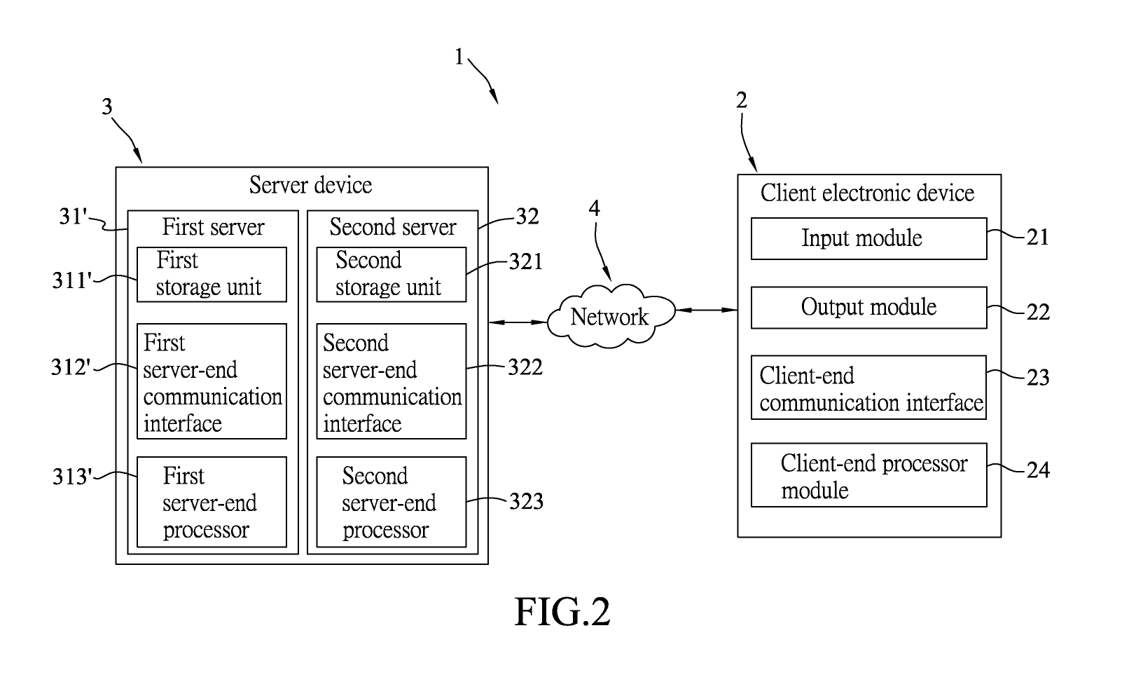

Referring to FIG. 2, in a second embodiment of the server device 3, the server device 3 includes a first server 31′ and a second server 32. The first server 31′ includes a first storage unit 311′, a first server-end communication interface 312′ configured to connect to the network 4, and a first server-end processor 313′ coupled electrically to the first storage unit 311′ and the first server-end communication interface 312′. The second server 32 includes a second storage unit 321, a second server-end communication interface 322 configured to connect to the network 4, and a second server-end processor 323 coupled electrically to the second storage unit 321 and the second server-end communication interface 322. The first storage unit 311′ of the first server 31′ stores the learning scheduling program, the learning evaluation program, the text material, and the solution to the interactive inquiry. The second storage unit 321 of the second server 32 stores the AV material. The second server 32 may be regarded as a third-party AV server which is merely used to provide the AV material to the client electronic device 2. By using the second server 32 to provide the AV material, loading of the first server-end processor 313′ of the first server 31′ maybe alleviated, and smooth playback of the AV material may be facilitated. Specifically, the first storage unit 311′ and the second storage unit 321 cooperatively serve as the storage module 311, the first server-end communication interface 312′ and the second server-end communication interface 322 cooperatively serve as the server-end communication interface 312, and the first server-end processor 313′ and the second server-end processor 322 cooperatively serve as the server-end processor module 313.

Furthermore, said another education course material includes a portion of the education course material, and is partially identical to the education course material. However, in a variation of this embodiment, said another education course material may be completely identical to or entirely distinct from the education course material. Details of the education course material and said another education course material will be explained in combination with a first embodiment of a distance education method and an exemplary scenario hereinafter.

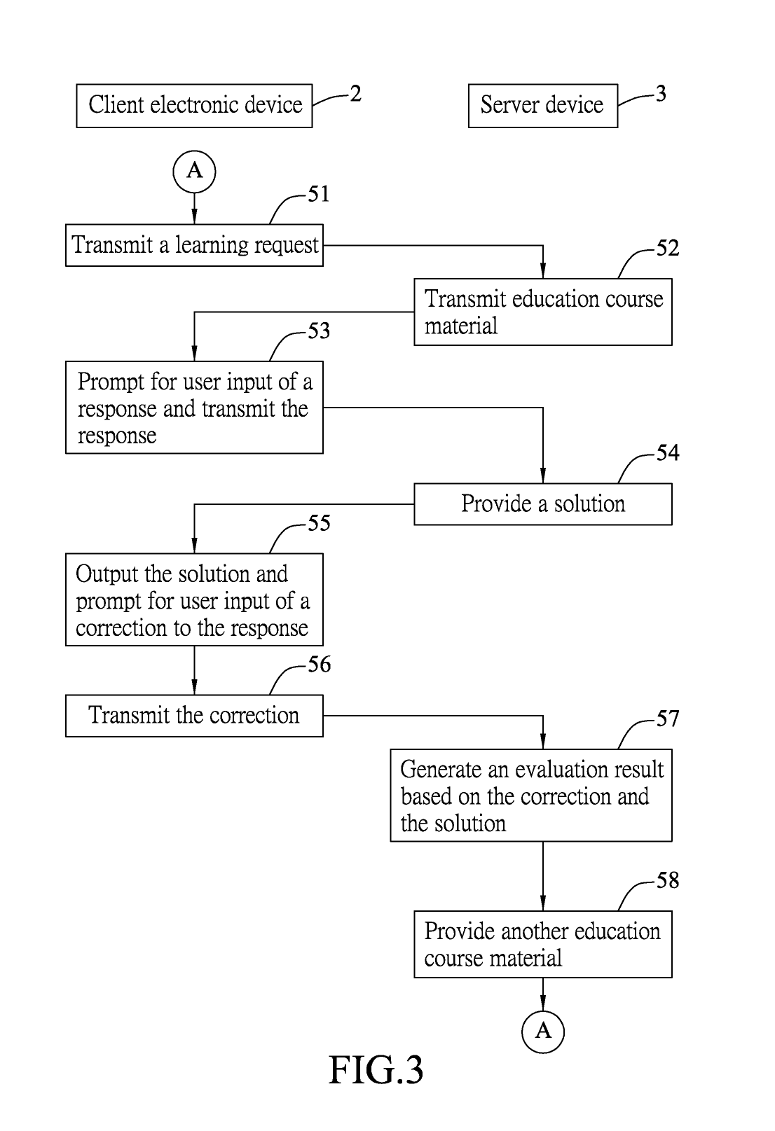

Referring to FIG. 1 and FIG. 3, the first embodiment of the distance education method according to the disclosure is to be implemented by the language learning system 1, and includes the following steps.

Instep 51, the client electronic device 2 transmits a learning request to the server device 3.

In step 52, in response to receipt of the learning request from the client electronic device 2, the server device 3 transmits the education course material to the client electronic device 2.

In step 53, the client electronic device 2 prompts for user input of the response to the interactive inquiry of the education course material, and transmits the response to the server device 3.

In step 54, in response to receipt of the response from the client electronic device 2, the server device 3 provides the solution to the interactive inquiry to the client electronic device 2.

In step 55, in response to receipt of the solution from the server device 3, the client electronic device 2 outputs the solution, and prompts for user input of the correction to the response to the interactive inquiry.

In step 56, the client electronic device 2 transmits the correction to the server device 3.

In step 57, in response to receipt of the correction from the client electronic device 2, the server device 3 generates the evaluation result based on the correction and the correct response.

In step 58, the server device 3 provides said another education course material to the client electronic device 2 based on the evaluation result. Specifically, said another education course material includes a portion of the education course material transmitted in step 52.

Afterward, the flow goes back to step 51. Specifically, said another education course material provided in step 58 serves as the education course material transmitted in step 52 for the user's next learning procedure.

For example, when the user utilizes the distance education method of the disclosure for daily learning, steps 51 to 58 are performed each day. Therefore, the day when the distance education method is used for the first time is defined as the first day to use the distance education method. Similarly, the day when the distance education method is used for the second time is defined as the second day to use the distance education method, and so forth. Therefore, the Nth day to use the distance education method is the day when the distance education method is used for the Nth time.

Note that steps of 51 to 58 of the distance education method of this disclosure are performed once a day. However, depending on different needs, these steps may be performed twice or more per day, or performed every other day, and should not be limited to the disclosure herein.

On the first day, the education course material transmitted in step 52 includes a first lesson video which includes a plurality of first lesson phrases associated with the foreign language, texts of the first lesson phrases, a first explanatory video which includes a plurality of first explanatory statements associated with the first lesson phrases, texts of the first explanatory statements. Said another education course material provided in step 58 includes the first lesson video, the texts of the first lesson phrases, a second lesson video which includes a plurality of second lesson phrases associated with the foreign language, texts of the second lesson phrases, a second explanatory video which includes a plurality of second explanatory statements associated with the second lesson phrases, and texts of the second explanatory statements. Specifically, said another education course material provided in step 58 on the first day may serve as the education course material transmitted the next day (i.e., on the second day).

It is noted that playback speed and vocabulary difficulty of the second explanatory statements of the second explanatory video provided in step 58 may vary based on the evaluation result. For example, when the evaluation result is great (i.e., the number of mispronounced words and/or the number of mistranslated words are smaller than a first predefined threshold value), the second explanatory video of said another education course material is one in which the playback speed of the second explanatory statements is boosted and the vocabulary difficulty of the same is increased. In contrast, when the evaluation result is inferior (i.e., the number of mispronounced words and/or the number of mistranslated words are greater than a second predefined threshold value), the second explanatory video of said another education course material is one in which the playback speed of the second explanatory statements is reduced and the vocabulary difficulty of the same is decreased.

In the variation of this embodiment where said another education course material may be completely identical to or entirely distinct from the education course material transmitted in step 52. For example, on the first day, the education course material transmitted to the client electronic device 2 in step 52 includes the first lesson video, the texts of the first lesson phrases of the first lesson video, the first explanatory video, and the texts of the first explanatory phrases of the first explanatory video. Afterward, when the evaluation result generated in step 57 is great, said another education course material provided to the client electronic device 2 in step 58 may include the second lesson video, the texts of the second lesson phrases of the second video, the second explanatory video, and the texts of the second explanatory statements of the second explanatory video, instead of the first lesson video, the texts of the first lesson phrases, the first explanatory video, and the texts of the first explanatory statements, such that new education course material can be provided to the user who does not need to review again the education course material that has been learnt. However, when the evaluation result generated in step 57 is inferior, said another education course material provided to the client electronic device 2 in step 58 may include the first lesson video, the texts of the first lesson phrases, the first explanatory video, and the texts of the first explanatory statements, such that the same education course material of the first day can be reviewed again by the user.

Back to this embodiment, on the second day, the education course material transmitted to the client electronic device 2 in step 52 includes the first lesson video, the texts of the first lesson phrases, the second lesson video, the texts of the second lesson phrases, the second explanatory video, and the texts of the second explanatory statements. Said another education course material transmitted to the client electronic device 2 in step 58 includes the first lesson video, the texts of the first lesson phrases, the second lesson video, the texts of the second lesson phrases, a third lesson video which includes a plurality of third lesson phrases associated with the foreign language, texts of the third lesson phrases, a third explanatory video which includes a plurality of third explanatory statements associated with the third lesson phrases, and texts of the third explanatory statements. Specifically, said another education course material provided in step 58 on the second day can serve as the education course material transmitted in step 52 of the next learning procedure (i.e., the education course material transmitted in step 52 on the third day).

On the third day, the education course material transmitted to the client electronic device 2 in step 52 includes the first lesson video, the texts of the first lesson phrases, the second lesson video, the texts of the second lesson phrases, the third lesson video, the texts of the third lesson phrases, the third explanatory video, and the texts of the third explanatory statements. Said another education course transmitted to the client electronic device 2 in step 58 includes the first lesson video, the second lesson video, the texts of the second lesson phrases, the third lesson video, the texts of the third lesson phrases, a fourth lesson video which includes a plurality of fourth lesson phrases associated with the foreign language, texts of the fourth lesson phrases, a fourth explanatory video which includes a plurality of fourth explanatory statements associated with the fourth lesson phrases, and texts of the fourth explanatory statements. Specifically, said another education course material provided in step 58 on the third day can serve as the education course material transmitted in step 52 of the next learning procedure (i.e., the education course material transmitted in step 52 on the fourth day).

With respect to learning of the first lesson video, on the first day, aside from providing the first lesson video to the client electronic device 2, the texts of the first lesson phrases of the first lesson and the first explanatory video associated with the first lesson phrases are also provided to the client electronic device 2 for the user's better under standing of the first lesson phrases. On the second and third days, the first lesson video and the texts of the first lesson phrases are still provided to the client electronic device 2 for being reviewed by the user of the first lesson phrases learnt on the first day. However, on the fourth day, only the first lesson video is provided to the user for dictation practice of the first lesson phrases. During the process that the user listens to the first lesson phrases and then translates or takes dictations of the first lesson phrases, the user may have better listening comprehensibility, and may have better understanding and memorization of pronunciation, grammar and syntax of the foreign language.

Note that, in the exemplary learning scenario, the first lesson video is only provided in the absence of the texts of the first lesson phrases to the client electronic device 2 for dictation practice of the first lesson phrases by the user on the fourth day of the learning procedure. However, in other examples, dictation practice may be provided on one of the first, second and third days based on different needs of the user.

On the fourth day, the education course material transmitted to the client electronic device 2 in step 52 includes the first lesson video, the second lesson video, the texts of the second lesson phrases, the third lesson video, the texts of the third lesson phrases, the fourth video, the texts of the fourth lesson phrases, the fourth explanatory video, and the texts of the fourth explanatory statements. Said another education course transmitted to the client electronic device 2 in step 58 includes the second lesson video, the third lesson video, the texts of the third lesson phrases, the fourth lesson video, the texts of the fourth lesson phrases, a fifth lesson video which includes a plurality of fifth lesson phrases associated with the foreign language, texts of the fifth lesson phrases of the fifth lesson video, a fifth explanatory video which includes a plurality of fifth explanatory statements associated with the fifth lesson phrases, and texts of the fifth explanatory statements of the fifth explanatory video. Specifically, said another education course material provided in step 58 on the fourth day can serve as the education course material transmitted in step 52 of the next learning procedure (i.e., the education course material transmitted in step 52 on the fifth day).

In a similar fashion, on the N^{th} day, the education course material transmitted to the client electronic device 2 in step 52 includes the N−3^{th} lesson video, the N−2^{th} lesson video, the texts of the N−2^{th} lesson phrases, the N−1^{th} lesson video, the texts of the N−1^{th} lesson phrases, the N^{th} video, the texts of the N^{th} lesson phrases, the N^{th} explanatory video, and the texts of the N^{th} explanatory statements. Said another education course transmitted to the client electronic device 2 in step 58 includes the N−2^{th} lesson video, the N−1^{th} lesson video, the texts of the N−1^{th} lesson phrases, the N^{th} lesson video, the texts of the N^{th} lesson phrases, an N+1^{th} lesson video which includes a plurality of N+1^{th} lesson phrases associated with the foreign language, texts of the N+1^{th} lesson phrases, an N+1^{th} explanatory video which includes a plurality of N+1^{th} explanatory statements associated with the N+1^{th} lesson phrases, and text of the N+1^{th} explanatory statements of the N+1^{th} explanatory video. Specifically, said another education course material provided in step 58 of the N^{th} day can serve as the education course material transmitted in step 52 of the next learning procedure (i.e., the education course material transmitted in step 52 on the N+1^{th} day), and N is greater than 5.

Referring back to FIG. 1, a third embodiment of the server device 3 is different from the first embodiment thereof in that when the server-end processor module 313 receives the learning request from the client electronic device 2 via the server-end communication interface 312, the server-end processor module 313 executes the learning scheduling program to transmit the education course material as well as an encrypted solution, which is the solution encrypted beforehand, via the server-end communication interface 312 to the client-end communication interface 23. Subsequently, when the server-end processor module 313 receives the response from the client electronic device 2 via the server-end communication interface 312, the server-end processor module 313 executes the learning scheduling program to transmit a decryption key, which corresponds to the education course material and which is associated with the encrypted solution, via the server-end communication interface 312 to the client-end communication interface 23. Thereafter, when the client-end processor module 24 receives the decryption key from the server device 3 via the client-end communication interface 23, the client-end processor module 24 decrypts the encrypted solution using the decryption key so as to obtain the solution to the interactive inquiry, and then controls the output module 22 to output the solution. Specifically, the decryption key is stored in advance in the storage module 311.

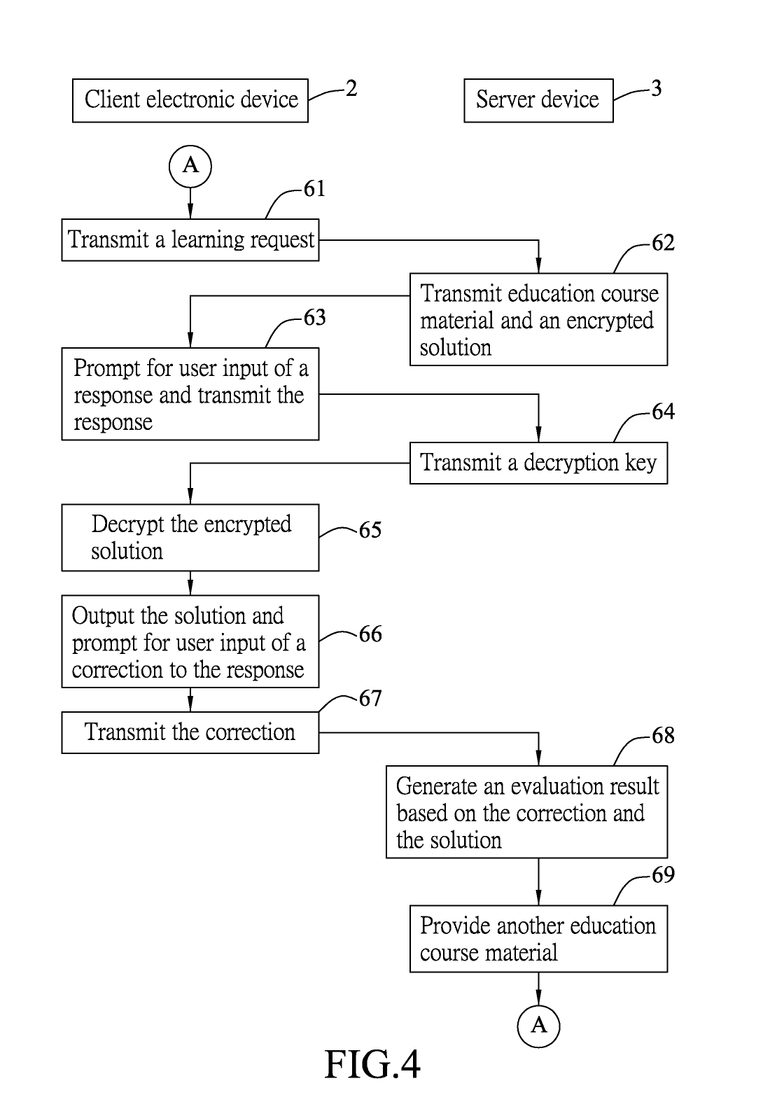

Referring to FIG. 1 and FIG. 4, a second embodiment of the distance education method according of the disclosure is similar to the first embodiment. Specifically, step 61, step 63 and steps 67 to 69 of FIG. 4 are identical to step 51, step 53 and steps 56 to 58 of FIG. 3, and the differences between the first and second embodiments of the distance education method reside in step 62 and steps 64 to 65.

In step 62, when the server device 3 receives the learning request from the client electronic device 2, the server device 3 transmits the education course material and the encrypted solution, which is the solution encrypted beforehand and which corresponds to the education course material, to the client electronic device 2.

In step 64, when the server device 3 receives the response to the interactive inquiry of the education course material from the client electronic device 2, the server device 3 transmits the decryption key, which is associated with the encrypted solution and which corresponds to the education course material, to the client electronic device 2.

In step 65, the client electronic device 2 decrypts the encrypted solution using the decryption key so as to obtain the solution to the education course material.

In step 66, the client electronic device 2 outputs the solution obtained in step 65, and prompts for user input of the correction of the response to the education course material. The flow then proceeds to step 67.

To sum up, by means of the server device 3 which generates the evaluation result based on the correction to the response and the correct response, to which the solution corresponds, to the interactive inquiry of the education course material, the user learning outcome of the education course material may be determined. Moreover, by means of the server device 3 providing another education course material to the client electronic device 2 based on the evaluation result (e.g., with a playback speed and vocabulary difficulty chosen based on the evaluation result), an object that the education course material can be provided in a manner suitable for the user's learning ability may be achieved. In addition, for each of the lesson videos, different learning modes are provided to the user. For example, when a lesson video is provided to the user for the first time, corresponding texts of lesson phrases and a corresponding explanatory video and associated texts are also provided to enhance learning by the user. At the second time and third time of learning the same lesson video, the texts of the lesson phrase s are still provided to deepen the learning effect. At the fourth time of learning the same lesson video, only the lesson video is provided to the user for dictation practice so as to strengthen and enhance the learning effect.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A distance education method to be implemented by a server device which communicates with a client electronic device through a network, the distance education method comprising the steps of:
after receiving a learning request from the client electronic device, transmitting education course material to the client electronic device, the education course material including an interactive inquiry and enabling the client electronic device to prompt for user input of a response to the interactive inquiry and to transmit the response to the server device;
providing a solution to the interactive inquiry to the client electronic device, the solution enabling the client electronic device to prompt for user input of a correction to the response to the interactive inquiry and to transmit the correction to the server device; and
after receiving the correction from the client electronic device, generating an evaluation result, which is associated with a user learning outcome of the education course material, based on the correction and the solution.

2. The distance education method of claim 1, wherein the step of providing a solution to the interactive inquiry of the education course material includes:
providing the solution to the client electronic device after receiving the response from the client electronic device, the solution enabling the client electronic device to output the solution.

3. The distance education method of claim 1, wherein the step of providing a solution to the interactive inquiry of the education course material includes:
providing an encrypted solution, which is the solution encrypted beforehand, to the client electronic device; and
transmitting a decryption key associated with the encrypted solution to the client electronic device after receiving the response from the client electronic device, the decryption key enabling the client electronic device to decrypt the encrypted solution using the decryption key so as to obtain the solution to the interactive inquiry, the solution enabling the client electronic device to output the solution.

4. The distance education method of claim 1, subsequent to the step of generating an evaluation result, further comprising the step of:
providing another education course material to the client electronic device based on the evaluation result.

5. The distance education method of claim 4, wherein, subsequent to the step of providing another education course material, the flow goes back to the step of transmitting education course material, and said another education course material serves as the education course material transmitted to the client electronic device in the repeated step of transmitting education course material.

6. The distance education method of claim 4,
wherein said another education course material includes a portion of the education course material;
wherein the step of transmitting education course material includes transmitting first audio/video (AV) material, first text material corresponding to the first AV material, second AV material corresponding to the first AV material, and second text material corresponding to the second AV material;
wherein the step of providing another education course material includes providing the first AV material, the first text material, third AV material, third text material corresponding to the third AV material, fourth AV material corresponding to the third AV material, and fourth text material corresponding to the fourth AV material; and
wherein the first AV material includes a first lesson video which i s associated with a language learning course and which includes a plurality of first lesson phrases associated with the language, the first text material includes texts of the plurality of first lesson phrases, the second AV material includes a first explanatory video which is associated with the first lesson video, the first explanatory video includes a plurality of first explanatory statements which are associated with the first lesson phrases, the second text material includes texts of the plurality of first explanatory statements, the third AV material includes a second lesson video which is associated with the language learning course and which includes a plurality of second lesson phrases associated with the language, the third text material includes texts of the plurality of second lesson phrases, the fourth AV material includes a second explanatory video which is associated with the second lesson video, the second explanatory video includes a plurality of second explanatory statements which are associated with the second lesson phrases, and the fourth text material includes texts of the plurality of second explanatory statements.

7. A distance education method to be implemented by a client electronic device which communicates with a server device through a network, the distance education method comprising the steps of :
transmitting a learning request to the server device, the learning request enabling the server device to transmit education course material to the client electronic device, the education course material including an interactive inquiry;
prompting for user input of a response to the interactive inquiry of the education course material;
transmitting the response to the server device;
obtaining a solution to the interactive inquiry of the education course material from the server device;
prompting for user input of a correction to the response; and
transmitting the correction to the server device, the correction enabling the server device to generate an evaluation result, which is associated with a user learning out come of the education course material, based on the correction and the solution.

8. The distance education method of claim 7,
wherein in the step of transmitting the response to the server device, the response enables the server device to provide the solution to the client electronic device; and
wherein the step of obtaining a solution to the education course material includes outputting the solution.

9. The distance education method of claim 7, wherein the step of obtaining a solution to the education course material includes:
receiving an encrypted solution, which is the solution encrypted beforehand, from the server device;
receiving a decryption key associated with the encrypted solution from the server device after transmitting the response to the server device;
decrypting the encrypted solution using the decryption key so as to obtain the solution to the interactive inquiry of the education course material; and
outputting the solution.

10. The distance education method of claim 7, subsequent to the step of transmitting the correction to the server device, further comprising the step of:
receiving another education course material from the server device, said another education course being provided by the server device based on the evaluation result.

11. The distance education method of claim 10, wherein, subsequent to the step of receiving another education course material, the flow goes back to the step of transmitting a learning request, and said another education course material serves as the education course material transmitted to the client electronic device in the repeated step of transmitting a learning request.

12. A server device for providing distance education, said server device communicating with a client electronic device through a network and comprising:
a server-end communication interface configured to connect to the network; and
a server-end processor module coupled electrically to said server-end communication interface, and configured to
after receiving the learning request via said server-end processor module, transmit education course material to the client electronic device via said server-end processor module, the education course material including an interactive inquiry and enabling the client electronic device to prompt for user input of a response to the interactive inquiry of the education course material and to transmit the response to the server device,
provide a solution to the interactive inquiry to the client electronic device, the solution enabling the client electronic device to prompt for user input of a correction to the response and to transmit the correction to said server device, and
after receiving the correction from the client electronic device via said server-end communication interface, generate an evaluation result, which is associated with a user learning outcome of the education course material, based on the correction and the solution.

13. A server device of claim 12, wherein said server-end processor module is further configured to:
provide an encrypted solution, which is the solution encrypted beforehand, to the client electronic device; and
transmit a decryption key associated with the encrypted solution to the client electronic device after receiving the response from the client electronic device, the decryption key enabling the client electronic device to decrypt the encrypted solution using the decryption key so as to obtain the solution to the interactive inquiry of the education course material, the solution enabling the client electronic device to output the solution.

14. The server device of claim 12, wherein said server-end processor module is further configured to:
provide another education course material to the client electronic device based on the evaluation result.

15. The server device of claim 14, further comprising:
a storage module coupled electrically to said server-end processor module, and storing the education course material, said another education course material and the solution to the education course material; and
wherein the education course material and said another education course material include a plurality of audio/video (AV) materials and a plurality of text materials corresponding to the plurality of AV materials.

16. The server device of claim 15, further comprising:
a first server including a first storage unit which stores the solution to the interactive inquiry of the education course material, and the plurality of text materials of the education course material and said another education course material; and
a second server including a second storage unit which stores the plurality of AV materials of the education course material and said another education course material;
wherein said first storage unit and said second storage unit cooperatively serve as the storage module of said server device.

17. The server device of claim 14, further comprising:
a storage module coupled electrically to said server-end processor module, and storing a learning scheduling program and a learning evaluation program to be executed by said server-end processor module;
wherein said server-end processor module, in response to receipt of the learning request, executes the learning scheduling program to transmit the education course material, and to transmit the solution to the interactive inquiry of the education course material upon receipt of the response to the interactive inquiry; and
wherein said server-end processor module executes the learning evaluation program to generate the evaluation result based on the correction and the solution, and executes the learning scheduling program to provide said another education course material based on the evaluation result.
